(19) United States
(12) Patent Application Publication
(10) Pub. No.: US 2024/0131483 A1
(43) Pub. Date: Apr. 25, 2024

(54) METHOD OF MAKING A MAGNETIC MATERIAL AND A FLUIDIZED BED MIXER FOR MAKING THE SAME

(71) Applicant: GM Global Technology Operations LLC, Detroit, MI (US)

(72) Inventors: Qigui Wang, Rochester Hills, MI (US); Yucong Wang, West Bloomfield, MI (US)

(21) Appl. No.: 18/049,012

(22) Filed: Oct. 23, 2022

(51) Int. Cl. B01F 33/40; B01F 23/60; B01F 23/80; B01F 35/00; B22F 3/10; B22F 9/04; H01F 1/057

(52) U.S. Cl. CPC B01F 33/401; B01F 23/69; B01F 23/804; B01F 23/81; B01F 35/55; B22F 3/10; B22F 9/04; H01F 1/0577; B22F 2301/355; B22F 2998/10

(57) ABSTRACT

A fluidized bed mixer for combining a first powder with a second powder for manufacturing a magnet and a method of using the fluidized bed mixer for making the magnet. The first powder material is an alloy powder containing neodymium (Nd), iron (Fe), and boron (B), and the second powder material is an alloy powder or elemental metal powder containing one or more of dysprosium (Dy) and terbium (Tb). The fluidized bed mixer includes a fluidized bed portion in an upper portion of a mixing chamber, a cascading baffle system beneath the fluidized bed portion, and combined powder collection area beneath the cascading baffle system. The fluidized bed mixer is configured to homogenously combine a first powder material with a second powder material in such a way that particles of the second powder material adheres to and covers the outer surfaces of the particles of the first powder material.

### INTRODUCTION

The present disclosure relates to a method of making a magnet for an electric motor, more particularly to a method of utilizing a fluidized bed mixer to make a magnetic material and a fluidized bed mixer for making the magnetic material.

In an electric motor, an electric current is conveyed through windings in the stator to generate a moving magnetic field that interacts with a rotor disposed within the stator to generate a torque that turns the rotor. Synchronous type electric motors are typically used in propulsion systems for electric and hybrid vehicles. In a typical synchronous electric motor, the rotor uses permanent magnets to produce a constant magnetic field (CMF) that interacts with a rotating magnetic field (RMF) generated by a three-phase alternating current (AC) supplied to a field coil of the stator. The permanent magnets used in the rotor are usually formed of magnetic materials made of expensive rare earth materials in order for the permanent magnets to have a sufficient magnetic field to maintain engagement with the RMF.

Thus, while the current method of making permanent magnets achieve their intended purpose, there is a continual need to ensure a homogenous mixture of combined core and rear earth powders in the making of the magnetic materials for permanent magnets and to increase the rate of production of such magnetic materials to meet the demands of compact electric motors.

### SUMMARY

According to several aspects, a method of making a magnetic material is disclosed. The method includes mixing a first powder material with a second powder material in a fluidized bed mixer to form a combined powder material, milling the combined powder material, and sintering the milled combined powder material into a solid structure. The first powder material includes neodymium (Nd), iron (Fe), and boron (B) and the second powder material includes one or more of dysprosium (Dy) and terbium (Tb). The combined powder material includes particles comprising a core having Nd, Fe, and B, and a surface coated with one or more of Dy and Tb.

In an additional aspect of the present disclosure, the first powder material is gravity fed into a top portion of the fluidized bed mixer and the second powder material is sprayed into the fluidized bed mixer such that the second powder material collides with the first powder material and coats the surface of the first powder material.

In another aspect of the present disclosure, the first powder material includes one of a positive charge and a negative charge, and the second powder material includes the other of the positive charge and the negative charge. A solvent may be sprayed onto the first powder material and the second powder material in the fluidized bed mixer. Such solvents may include methanol, ethanol, kerosene, and/or gasoline.

In another aspect of the present disclosure, the method further includes injecting a flow of an inert gas into the fluidized bed reactor sufficient to maintain the first powder material and the second powder material suspended in a fluidized bed but allows the combined powder material to drop out of the fluidized bed. The combined powder material dropped out of the fluidized bed is homogenized through a cascading baffle system.

In another aspect of the present disclosure, the method further includes milling the combined powder material exiting the cascading baffle system in a rotating drum and ball miller. A solvent such as methanol, ethanol, kerosene, and/or gasoline may be added in the milling process. The milled combined powder material may be again passed through the fluidized bed mixer for drying aided with a flow of heated inert gas.

According to several aspects, a fluidized bed mixer for making a magnetic material is disclosed. The fluidized bed mixer includes a housing having an interior surface defining a mixing chamber, a fluidized bed portion in an upper portion of the mixing chamber, a cascading baffle system in a middle portion of the mixing chamber below the fluidized bed portion, and a combined powder material collection area in a lower portion of the mixing chamber beneath the cascading baffle system.

In an additional aspect of the present disclosure, the fluidized bed mixer further includes a first powder inlet configured to gravity feed the first powder material into the fluidized bed portion, and at least one injection nozzle configured to inject a stream of the second powder material into the fluidized bed portion such that the second powder material collides with the first powder material to form a plurality of particles having a core of the first powder material and a surface coated with the second powder material.

In an additional aspect of the present disclosure, the fluidized bed mixer further includes a gas inlet to convey a stream of inert gas to maintain the first powder material and the second powder material suspended in a fluidized bed while allowing the combined powder material to drop out of the fluidized bed. The stream of inert gas may be heated prior to entering the fluidized bed mixer.

In another aspect of the present disclosure, the cascading baffle system includes a plurality of baffle plates. Each of the baffle plates includes a first end attached to the interior surface of the wall and an opposite second end angled downward across the centerline-A of the mixing chamber. The baffle plates are arranged in a descending alternating order such that the plurality of particles flows from an upper baffle plate to a lower baffle plate in a cascading order. One or more of the baffle plates are perforated.

In another aspect of the present disclosure, the fluidized bed mixer further includes at least one inert gas inlet disposed between a pair of baffle plates and an inert gas outlet located above the fluidized bed portion.

According to several aspects, the fluidized bed mixer further includes a first electrostatic sprayer configured to charge the first powder material with one of a positive and a negative charge, and a second electrostatic sprayer configured to charge the second powder material with the other of the positive charge and the negative charge.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a fluidized bed mixer, according to an exemplary embodiment;

FIG. 2 is a schematic illustration of a ball miller, according to an exemplary embodiment;

FIG. 3 is a block diagram of a method of making a magnetic material, according to an exemplary embodiment;

FIG. 4A is a diagrammatic illustration of the powder mixture at a step of the method, according to an exemplary embodiment;

FIG. 4B is a diagrammatic illustration of the powder mixture at another step of the method, according to an exemplary embodiment; and

FIG. 4C is a diagrammatic illustration of the powder mixture at yet another step of the method, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

Permanent magnets having magnetic materials manufactured of rear earth materials have a higher energy density than most other magnets and thus enable more compact and powerful electric motors. Such rear earth material permanent magnets are also used in other automotive applications such as starters, small motors, alternators, sensors, meters, and other uses requiring a rotational torque. The manufacture of magnetic materials for such permanent magnets includes combining a core powder material containing neodymium (Nd), iron (Fe), and boron (B), with a rear earth powder material containing one or more of dysprosium (Dy) and terbium (Tb) in a predetermined ratio to form a combined powder mixture. It is desirable for the combined powder mixture to have the rear earth containing powder material particles to be evenly distributed on the surface of the core powder material particles. The combined powder mixture is then mechanically milled and sintered to form the magnetic material.

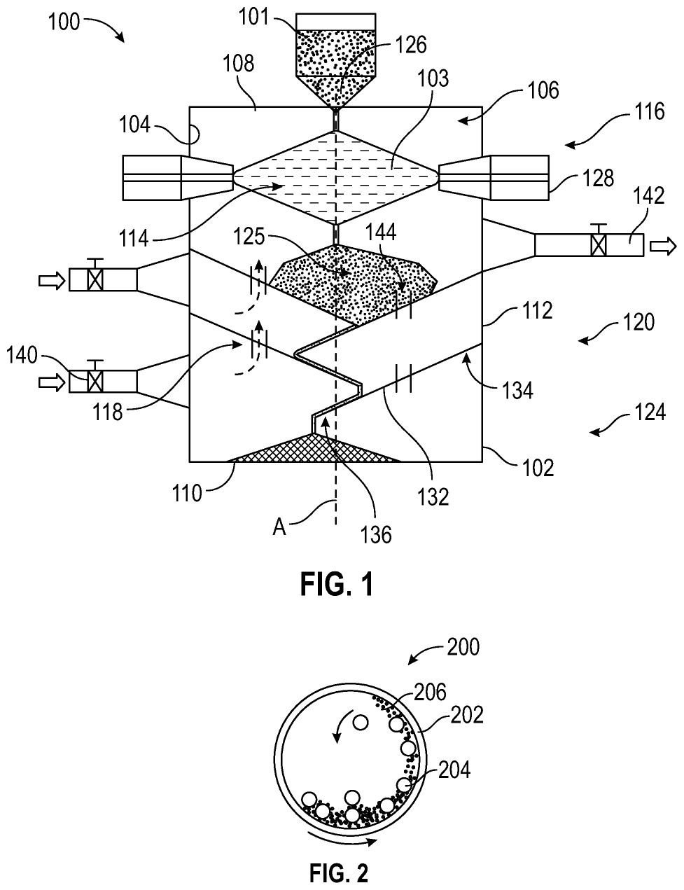

FIG. 1 shows a schematic illustration of a fluidized bed mixer 100 for combining a first powder material 101 with a second powder material 103 for manufacturing a magnetic material that may be used in permanent magnets in electric motors. The fluidized bed mixer 100 is configured to homogenously combine a first powder material 101 with a second powder material 103 in such a way that particles of the second powder material 103 evenly adheres to and covers the outer surfaces of the particles of the first powder material 101. The first powder material 101 is an alloy powder containing neodymium (Nd), iron (Fe), and boron (B), and the second powder material 103 is an alloy powder or elemental metal powder containing one or more of dysprosium (Dy) and terbium (Tb).

The fluidized bed mixer 100 includes a housing 102 having an interior surface 104 defining a mixing chamber 106 extending along a central axis-A, also referred to as the centerline. The housing 102 includes a top wall 108, a bottom wall 110 spaced from the top wall 108, and a side wall 112 connecting the top wall 108 to the bottom wall 110. The mixing chamber 106 includes a fluidized bed portion 114 in an upper portion 116 of the mixing chamber 106 proximal to the top wall 108, a cascading baffle system 118 in a mid-portion 120 of the mixing chamber below the fluidized bed portion 114, and a combined powder material collection area beneath the cascading baffle system 118 in a lower portion 124 of the mixing chamber proximal to the bottom wall 110.

The fluidized bed mixer 100 further includes a first powder inlet 126 configured to gravity feed the first powder material 101 into the fluidized bed portion 114 and at least one injection nozzle 128 configured to inject a stream of the second powder material 103 into the fluidized bed portion 114. The first powder inlet 126 is located proximal to the top wall 108. The at least one injection nozzle 128 is configured to inject the stream of second powder material 103 by using a compressed inert gas such as nitrogen or argon. The stream of second powder material 103 is injected into the fluidized bed portion 114 in such a way that the stream of second powder material 103 collides with the first powder material 101 as the first powder material 101 is gravity fed through the inlet 126. In the embodiment shown, a pair of injectors 128 inject a stream of second powder material 103 such that the second powder material 103 intersects the path of the first powder material 103 at an approximate 90-degree angle.

Located below the fluidized bed portion 114, with respect to the direction of gravity, is the cascading baffle system 118 having a plurality of perforated plates 132. Each of the perforated plates includes a first end 134 extending from the interior surface 104 of the wall and an opposite second end 136 angled downward across the centerline-A. The perforated plates are arranged in such a way that a combined powder material 125 dropping out of the fluidized bed portion 114 flows in a cascading order from the upper plate to the lower plate. The combined powder material 125 flows through each plate in a cascading order until it settles on the bottom wall 110.

The fluidized bed mixer 100 further includes at least one inert gas inlet 140 and an inert gas outlet 142 located above the at least one inert gas inlet. The inert gas inlet 140 is configured to inject a stream of compressed inert gas upwards toward the fluidized bed portion 114 to maintain a fluidized bed of the first powder material 101 and the second powder material 103. In the embodiment shown, an inert gas inlet 140 is positioned between pairs of perforated plates. The stream of compressed inert gas aids in the further mixing of the combined powder material 125 as it cascades down the baffle system 118. The stream of compressed inert gas may be preheated to aid in the drying of the combined powder material 125.

The stream of compressed gas travels upwards to the fluidized bed through the alternating pathway defined by the alternating plates and through the perforation 144 of the plates. The volume and velocity of the inert gas entering the mixing chamber through the inert gas inlet 140 are sufficient to fluidize the powder material above the baffle system 118 before existing the inert gas outlet 142.

FIG. 2 shows a schematic illustration of a ball mill 200 for manufacturing the magnetic material. The magnetic material may be used to make a permanent magnet. The ball mill includes a rotating horizontal drum 202 partially filled with small steel balls 204. The drum 202 may be manufactured of stainless steel. The balls 204 may be made of stainless steel and coated with alumina, silicon carbide, silicon nitride, or ceramic. As the drum 202 rotates, the balls 204 drop on the combined powder 206 extracted from the fluidized bed mixer 100 and grind the combined powder 206 such that the second powder material 103 evenly coats the outer surface of the first powder material 101.

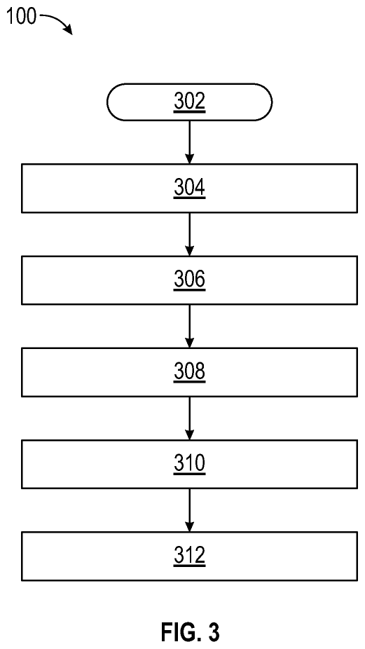

FIG. 3 is a block diagram of a method of making a magnetic material by using the fluidized bed mixer 100 of FIG. 1. The Method 300 starts in Block 302.

Moving to Block 304 from Block 302. In Block 304, a first powder material 101 containing an alloy comprising neodymium (Nd), iron (Fe), and boron (B) is provided. A second powder material 103 containing an alloy or elemental metal comprising one or more of dysprosium (Dy) and terbium (Tb) is provided. Dy or Tb or both can be used, as desired. A ratio of Dy to Tb of up to about 10 can be used if desired. The first powder material 101 and second powder material 103 each individually include a diameter in the range of about 1 to about 200 micrometers (μm).

Moving to Block 306 from Block 304, the first powder material 101 is gravity fed through the first powder material inlet 126 into the fluidized bed portion 114. The second powder material 103 is injected into the fluidized bed portion 114 such that the second powder material 103 intersects and collides with the first powder material 101 to form a combined powder material 125 having a core comprising the first powder material 101, in which the outer surface of the core is coated with the second powder material 103. A positive charge may be provided to the first powder material 101 and a negative charge to the second powder material 103. Alternatively, a negative charge may be provided to the first powder material 101 and a positive charge to the second powder material 103. A stream of compressed insert gas is injected upwards into the mixing chamber by the injection nozzles 128 to maintain the first powder material 101 and the second powder material 103 in a suspended fluidized bed.

As the first powder material 101 and the second powder material 103 are maintained in the fluidized bed, the second powder material 103 collides with the first powder material 101 in such a way that the second powder material 103 coats the outer surface of the first powder material 101. The opposite charges of the first powder material 101 and the second powder material 103 aids in the adhesion of the second powder material 103 onto the outer surface of the first powder material 101. The volume, pressure, and velocity of the stream of compressed inert gas is sufficient to maintain the first powder material 101 and the second powder material 103 suspended in the fluidized bed but allows the heavier combined powder material 125 to drop out of the fluidized bed.

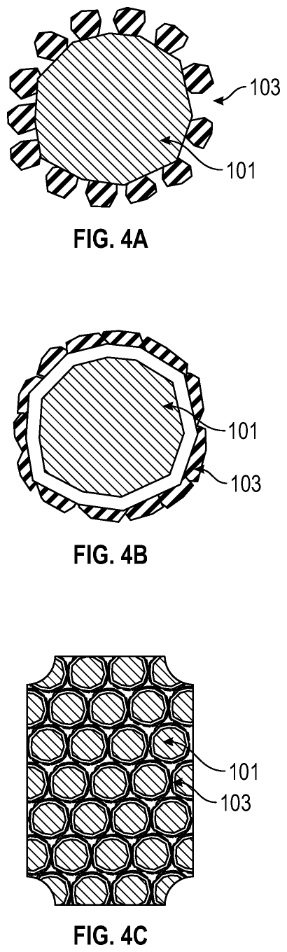

FIG. 4A is a diagrammatic illustration of the powder mixture at step 306 of the method. Once the outer surface of the first powder material 101 is coated with the second powder material 103, the combined powder material 125 becomes sufficiently heavy so that the combined powder material 125 drops out of the fluidized bed portion 114 and flows downward through the baffle system 118 to the combined powder material collection area. The coating of the second powder material 103 on the surface of the first powder material 101 by the fluidized bed mixer 100 provides a uniform distribution of Dy or Tb coating on the core powder material of Nd—Fe—B. The second powder material 103 forms a layer having a thickness of about 1 to about 100 microns.

Moving to Block 308 from Block 306, the combined powder material 125 is loaded into the ball mill along with the steel balls. The powder mixture is then milled for the desired length of time. The mill drum is operated at speed of about 50 to about 400 rpm, typically about 250 rpm. The milling time is about 0.5 to about 12 hours. The type, size, and size distribution of the grinding ball-to-powder weight ratio is about 1:10 to as high as about 20:1, with about 5:1 being typical). A solvent may be used in the milling process. During mechanical milling, an organic solvent such as methanol, ethanol, kerosene, gasoline can be added during the milling. The solvent is removed by heating after the milling by processing the milled combined powder material 125 in the fluidized bed mixer with a heated stream of inert gas. FIG. 4B is a diagrammatic illustration of the powder mixture at step 308 of the method after the milling process.

Moving to Block 310 from Block 308, hot isostatic pressing (HIP) may be used on the milled and dried combined powder material 125 to form the magnetic material. HIP is the simultaneous application of high temperature and pressure to metals and other materials for a specified amount of time in order to get a solid part for improving their mechanical properties. In the HIP process, a high temperature furnace is enclosed in a pressure vessel. The temperature, pressure and process times are all precisely controlled. The parts are heated in an inert gas, generally argon, which applies “isostatic” pressure uniformly in all directions. FIG. 4C is a diagrammatic illustration of the powder mixture at Block 310 of the method, according to an exemplary embodiment. In an alternative embodiment, hot pressing the materials in a die may be used instead of HIP.

Moving to Block 312 from Block 310, a permanent magnet is manufactured from the magnetic material formed in Block 310.

A fluidized bed of alloy particles suspended by a flow of inert gas exhibits fluid-like properties. Benefits of utilizing the fluidized bed reactor includes: 1) extremely high surface area contact between gas and solid per unit bed volume, 2) high relative velocities between the gas and the dispersed solid phase, 3) high levels of intermixing of the particulate phases, and 4) frequent particle-particle and particle-wall collisions. All these promote very uniform mixing of the two or more powders of different compositions such as Nb—Fe—B base powder and Dy and Tb alloy powder.

An object with a higher density than the buoyance force of the fluidized bed will sink, whereas an object with a lower density than the buoyance force of the fluidized bed will float, thus the fluidized bed can be considered to exhibit the fluid behavior expected of Archimedes' principle. The fluidized bed can be altered by changing the inert gas fraction, powder materials with different densities comparative to the fluidized bed can, by altering either the fluid or solid fraction, be caused to sink or float. In fluidized beds, the contact of the solid particles with the fluidization medium (inert gas) is greatly enhanced.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. A method of making a magnetic material comprising:
mixing a first powder material with a second powder material in a fluidized bed mixer to form a combined powder material;
milling the combined powder material; and
sintering the milled combined powder material into a solid structure.

2. The method of claim 1, wherein the first powder material comprises neodymium (Nd), iron (Fe), and boron (B) and the second powder material comprises one or more of dysprosium (Dy) and terbium (Tb).

3. The method of claim 2, wherein the combined powder material includes alloy particles comprising a particle core having Nd, Fe, and B, and a particle surface coated with one or more of Dy and Tb.

4. The method of claim 2, wherein the first powder material is gravity fed into a top portion of the fluidized bed mixer and the second powder material is sprayed into the fluidized bed mixer such that the second powder material collides with the first powder material.

5. The method of claim 4, wherein the first powder material includes one of a positive charge and a negative charge, and the second powder material includes the other of the positive charge and the negative charge.

6. The method of claim 5, further include spraying a solvent comprising at least one of a methanol, ethanol, kerosene, and gasoline onto the first powder material and the second powder material in the fluidized bed mixer.

7. The method of claim 6, further including injecting a flow of an inert gas into the fluidized bed mixer sufficient to maintain the first powder material and the second powder material suspended in a fluidized bed but allows the heavier combined powder material to drop out of the fluidized bed.

8. The method of claim 7, further comprising homogenizing the combined powder material dropped out of the fluidized bed through a cascading baffle system.

9. The method of claim 8, further comprising milling the combined powder material exiting the cascading baffle system in a rotating drum and ball miller; and spraying a solvent onto the combined powder material while milling.

10. The method of claim 9, further comprising drying the milled combined powder material in the fluidized bed mixer prior to sintering.

11. A fluidized bed mixer for making a magnetic material, comprising:
a housing having an interior surface defining a mixing chamber extending along a centerline;
a fluidized bed portion in an upper portion of the mixing chamber;
a cascading baffle system in a middle portion of the mixing chamber below the fluidized bed portion; and
a collection area beneath the cascading baffle system in a lower portion of the mixing chamber.

12. The fluidized bed mixer of claim 11 further comprising:
a first powder inlet configured to gravity feed a first powder material into the fluidized bed portion; and
at least one injection nozzle configured to inject a stream of the second powder material into the fluidized bed portion such that the second powder material collides with the first powder material to form a plurality of alloy particles having a core of the first powder material and a surface coated with the second powder material.

13. The fluidized bed mixer of claim 12 further comprising an inlet to convey a stream of inert gas to maintain the first powder material and the second powder material suspended in a fluidized bed while allowing the plurality of alloy particles to drop out of the fluidized bed.

14. The fluidized bed mixer of claim 11, wherein the cascading baffle system comprises:
a plurality of baffle plates, wherein each of the baffle plates includes a first end attached to the interior surface of the housing and an opposite second end angled downward across the centerline of the mixing chamber, wherein the baffle plates are arranged in a descending order such that the plurality of alloy particles flows from an upper baffle plate to a lower baffle plate in a cascading order.

15. The fluidized bed mixer of claim 14, wherein one or more of the baffle plates are perforated.

16. The fluidized bed mixer of claim 15, further comprising at least one inert gas inlet disposed between a pair of baffle plates and an inert gas outlet located above the fluidized bed portion.

17. The fluidized bed mixer of claim 16, further comprising a first electrostatic spray configured to charge the first powder material with one of a positive and a negative charge, and a second electrostatic spray configured to charge the second powder material with the other of the positive charge and the negative charge.

18. A method of making a magnetic material comprising:
mixing a first powder material with a second powder material in a fluidized bed to form a combined powder material; and
mixing the combined powder material dropped out of the fluidized bed through a cascading baffle system.

19. The method of claim 18, further comprising:
applying one of a positive charge and a negative charge to the first powder material prior entering the fluidized bed;
applying the other of the positive charge and the negative charge to the second powder material prior entering the fluidized bed; and
spraying a solvent onto the first powder material and the second powder material suspended in the fluidized bed.

20. The method of claim 19, further comprising:
milling the combined powder material;
adding a solvent to the combined powder material while milling; and
drying the milled combined powder material in the fluidized bed mixer.
